(19) United States
(12) Patent Application Publication
(10) Pub. No.: US 2017/0217372 A1
(43) Pub. Date: Aug. 3, 2017

(54) WIRELESS CAMERA SYSTEM FOR VEHICLE AND TRAILER

(71) Applicant: MAGNA ELECTRONICS INC., Auburn Hills, MI (US)

(72) Inventors: Yuesheng Lu, Farmington Hills, MI (US); Guner R. Sarioglu, Oakland Twp, MI (US); Richard C. Bozich, Canton, MI (US); John T. Wichlacz, Davison, MI (US); William J. Chundrlik, JR., Rochester Hills, MI (US); Ronald J. Karl, Oxford, MI (US); Horst D. Diessner, Rochester Hills, MI (US); Benjamin May, Lubs (DE); Jyothi P. Gali, Rochester Hills, MI (US)

(21) Appl. No.: 15/421,482

(22) Filed: Feb. 1, 2017

Related U.S. Application Data
(60) Provisional application No. 62/290,167, filed on Feb. 2, 2016.

(51) Int. Cl. B60R 1/00; B60R 16/02; H04N 5/247; H04N 7/18; H04N 5/232; B60D 1/62; B60R 16/027

(52) U.S. Cl. CPC B60R 1/003; B60D 1/62; B60R 16/0207; B60R 16/027; H04N 7/181; H04N 5/23293; H04N 7/188; H04N 5/247; B60R 2300/802; B60R 2300/205; B60R 2300/607; B60R 2300/105; B60R 2300/80; B60R 2300/107; B60R 2300/406

(57) ABSTRACT

A vision system for a vehicle towing a trailer includes a vehicle transceiver disposed at the vehicle and at least one trailer camera disposed at the trailer being towed by the vehicle and having a field of view exterior of the trailer. A trailer transceiver is disposed at a front exterior portion of the trailer and is operable to receive image data captured by the at least one trailer camera and to wirelessly transmit captured image data to the vehicle transceiver disposed at the vehicle when the vehicle is towing the trailer. A video display screen is disposed at the vehicle and viewable by a driver of the vehicle when the vehicle is towing the trailer. The video display screen is operable to display video images derived from captured image data received by the vehicle transceiver disposed at the vehicle.

### CROSS REFERENCE TO RELATED APPLICATION

The present application claims the filing benefits of U.S. provisional application Ser. No. 62/290,167, filed Feb. 2, 2016, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle and at a trailer towed by the vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a driver assistance system or vision system or imaging system for a vehicle that utilizes one or more cameras to capture image data representative of images exterior of the vehicle, and provides one or more trailer cameras at a trailer being towed by the vehicle. The image data captured by the trailer cameras is wirelessly communicated to a vehicle transceiver or control unit via a trailer transceiver that is disposed at a forward exterior portion of the trailer to enhance wireless communication between the trailer cameras and the vehicle transceiver or control unit. The vehicle transceiver may also be disposed at an exterior portion of the vehicle to further enhance the wireless communication. The trailer cameras may be hard-wired to the trailer transceiver (or to a trailer control unit that is hard-wired to the trailer transceiver) such that the trailer cameras do not communicate wirelessly to the trailer transceiver.

The present invention thus provides enhanced wireless communication of image data captured by one or more trailer cameras to the vehicle system, such as for processing of the captured image data (such as for object detection or backup assist or the like) or such as for display of video images at a display screen or head unit display or head up display or the like of the vehicle for viewing by the driver of the vehicle, such as during a trailer reversing maneuver or the like.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle and trailer with a vision system that incorporates cameras and transceivers in accordance with the present invention;

FIG. 2 is a block diagram of the vision system of FIG. 1;

FIG. 3 is a block diagram of another vision system of the present invention, shown without a trailer control unit; and

FIG. 4 is a block diagram of another vision system of the present invention, shown without a trailer control unit and without a vehicle control unit.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide display, such as a rearview display or a top down or bird's eye or surround view display or the like.

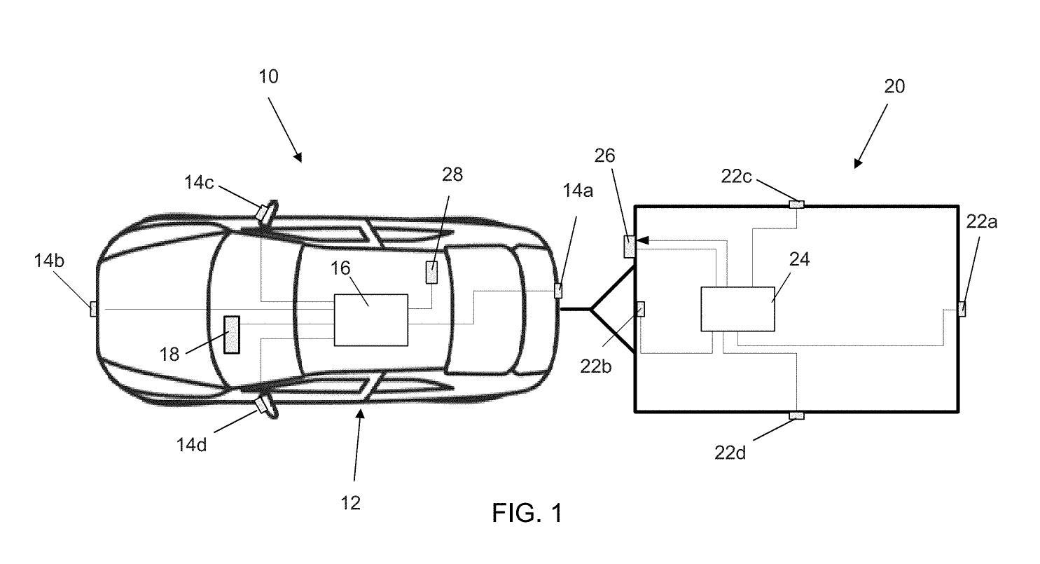

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sidewardly/rearwardly facing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor 16 that is operable to process image data captured by the camera or cameras and may detect objects or the like and/or provide displayed images at a display device 18 (such as a display screen or a head unit display or the like) for viewing by the driver of the vehicle. The data transfer or signal communication from the camera to the ECU may comprise any suitable data or communication link, such as a vehicle network bus or the like of the equipped vehicle.

As shown in FIG. 1, the vehicle 10 is towing a trailer 20, which is equipped with a plurality of exterior facing trailer cameras 22a, 22b, 22c, 22d for capturing image data representative of respective regions exterior of the trailer. The trailer cameras 22a-d capture image data and communicate or transmit the captured image data to a control unit 24 at the trailer 10. The control unit 24 receives signals from and transmits signals (such as image data captured by the trailer cameras) to a transceiver 26, which is operable to wirelessly transmit image data to a wireless transceiver 28 at the vehicle control unit 16, and which is operable to wirelessly receive signals from the transceiver 28. The trailer cameras 22a-d may be wired to the trailer control unit 24, which may also be wired to the trailer transceiver 26, whereby the trailer transceiver 26 wirelessly communicates with the vehicle transceiver 28. The trailer control unit 24 and trailer cameras 22a-d and trailer transceiver 26 may be powered via electrical connection to the trailer light wiring, which is powered via electrical connection to the vehicle harness when the trailer is connected to the vehicle for towing. Optionally, the trailer control unit and/or trailer cameras and/or trailer transceiver may be battery-powered, which may simplify installation and allow for enhanced flexibility of the system architecture.

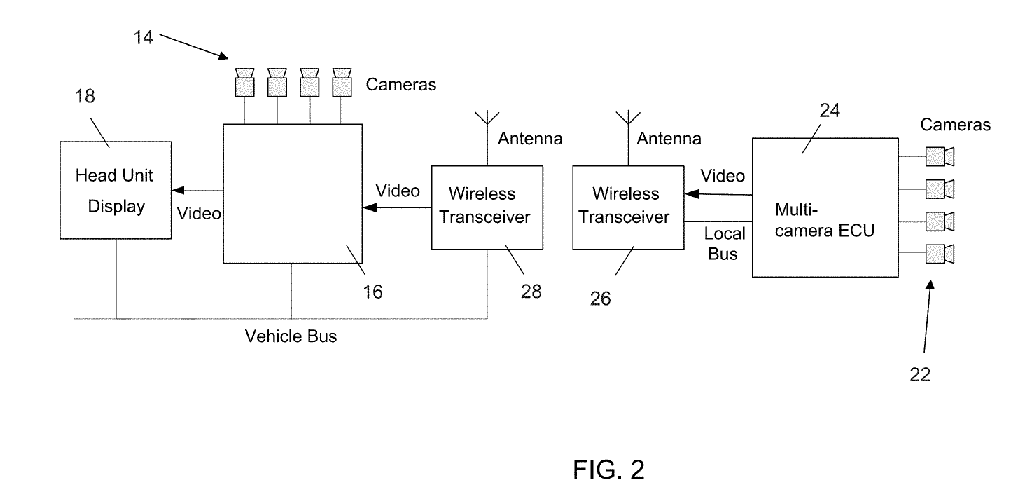

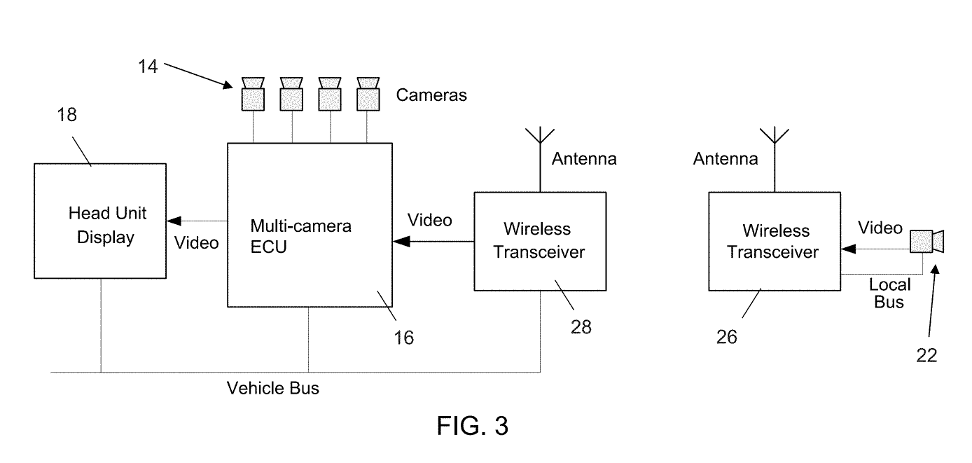

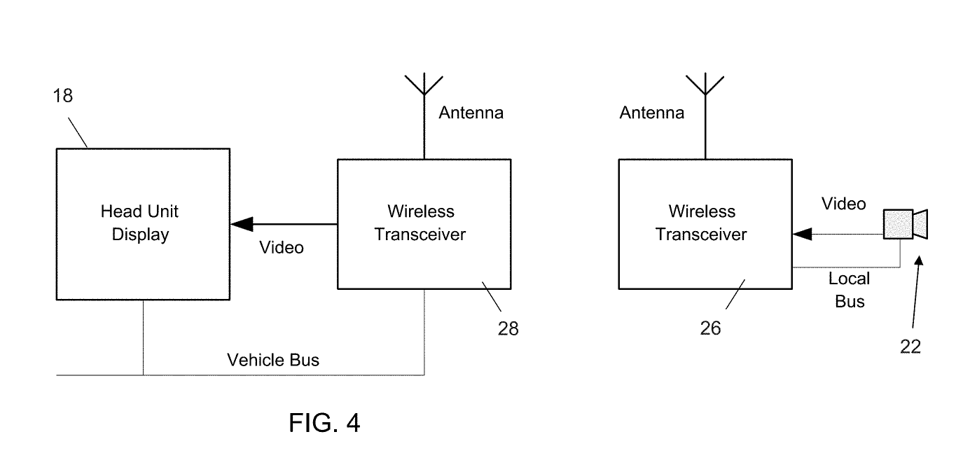

The present invention provides a wireless camera system that is used in a vehicle with a trailer. Wireless video transmission is a better way to transport video from a trailer to the pulling vehicle due to the difficulty of wiring between the trailer and the vehicle. FIGS. 2-4 depict different wireless camera solutions for trailer applications in accordance with the present invention. For example, FIG. 2 shows the system of FIG. 1, having a plurality of trailer cameras 22 and a plurality of vehicle cameras 14. FIG. 3 shows a system having a single trailer camera 22 (but could have more cameras at the trailer), which communicates directly with the trailer transceiver 26, while FIG. 4 shows a system having a single trailer camera 22 (but could have more cameras at the trailer), which communicates directly with the trailer transceiver 26, with the communicated image data being provided as a video feed to the display unit 18 (without a control unit or processor at the vehicle).

The transmission of video can be through Wi-Fi, Bluetooth, or other wireless means. The wireless communication or link may not only transmit video from the source to the receiver, but also may transmit control signals and other data via back channels or two way channels embedded in the wireless transmission channels. The back channel control signals may include vehicle related data, such as, for example, steering wheel angle, wheel speed, braking actions, PRNDL position, camera imager control commands, or other data. Such data can be used to control the camera or camera ECU in the trailer to do specific actions, such as, for example, (i) changing trailer camera views to zoom or pan to a specific area around trailer, (ii) changing trailer camera dynamic overlays and/or (iii) switching views between different trailer cameras.

The multi-camera ECU receives video from the trailer cameras wirelessly and may combine with other cameras at the vehicle to generate desired views and to send the video to a head unit/display for the driver to view so as to be able to see what is behind or around the vehicle and trailer. The control unit may process the captured image data (captured by the trailer cameras and/or vehicle cameras) to detect objects at or near the vehicle and may provide an alert to the driver if a hazardous condition is determined via such image processing. For example, with the wireless camera attached to the back of the trailer, the system may provide object and pedestrian detection, and the system may warn the driver of possible collisions when reversing the vehicle and trailer. Optionally, the system may control or operate in conjunction with the vehicle braking system and may provide automated braking to avoid collisions of the trailer and an object/pedestrian determined to be present behind or in the path of travel of the trailer during a reversing maneuver of the vehicle and trailer.

The wireless transceiver may optionally comprise a separate unit from the camera and may be placed on the wall of trailer facing the pulling or towing vehicle (see FIG. 1), with at least its antenna disposed exterior of the trailer wall. This approach may be preferred due to the possible complexity in electro-magnetic interference and excessive heat that affects image quality. Also, the location of the wireless transceiver and the attached antenna allows the electro-magnetic waves to be transmitted with minimum attenuation to ensure video transmission quality. Such a location is important for wireless transmissions with limited range (such as, for example, Wi-Fi), where the two metal walls between a rear mounted trailer camera and the receiver or transceiver in the towing vehicle could greatly attenuate the signals if the camera Wi-Fi transmitter were part of the camera at the rear part of the trailer. The video or data transmission between the trailer cameras and the wireless transceiver and/or multi-camera ECU may be through wires at the trailer, which is feasible inside the trailer. The power to the trailer cameras, wireless trailer transceiver and multi-camera trailer ECU may be from the typical trailer running light power that is provided by the pulling vehicle when the trailer wiring harness is connected to the vehicle wiring harness when hitching the trailer to the towing vehicle. Optionally, the transceiver may be disposed in one of the cameras (or each camera may include a respective transceiver).

Optionally, the communication link between the trailer and vehicle may function to communicate signals or data from other sensors at the trailer, such as ultrasonic sensors, radar sensors, lidar sensors or the like. Optionally, for example, the camera may control and interface with such auxiliary sensors and the transceiver may communicate the data captured by such auxiliary sensors via the wireless link.

Optionally, images derived from image data captured by the camera attached to the trailer may be displayed for viewing by the driver of the towing vehicle in order to select a trailer parking position via the HMI. The system, responsive to selection of a target trailer parking position, may autonomously maneuver the vehicle so that the trailer is moved into the selected parking position. The presence of a wireless camera or cameras at the rear and/or sides of the trailer make an autonomous trailer parking feature feasible.

Optionally, three wireless cameras can be added to a trailer (at both sides and at the rear of the trailer). The trailer camera views and the camera views of the vehicles surround view system can be stitched together to a full bird's eye surround view of the towing vehicle and the towed trailer. This view would show the blind spot areas next to tow vehicle and the trailer for viewing by the driver, thus enhancing the safety while backing up the trailer. Such wireless trailer camera technology would reduce the danger of blind spots next to the trailer and behind the trailer during a reversing maneuver of the vehicle and the trailer.

Because the camera transmits captured image data (and may receive control signals) wirelessly (and may be battery-powered, such that no wired connection is made to the camera), the camera may include additional elements or circuitry or the like, due to reduced restrictions on packing for the camera. For example, a wireless camera may include two imaging sensors and may operate on battery power and with wireless connectivity protocols (such as, for example, BLUETOOTH and/or Wi-Fi). Such a stereo camera may be used as a backup assist camera for reversing a vehicle with a trailer attached. For such an application, the stereo camera may be placed at the rear of the trailer and aimed so that the imagers capture image data of the scene rearward of the trailer, whereby the system may extract road pixels using the depth/disparity information (via the two spaced apart imagers capturing image data) for accurate path planning during the reversing maneuver. The stereo vision provided by the two imagers may also assist in accurately determining detected obstacles' physical locations using the depth information.

Optionally, such a stereo camera may be placed at the rear bumper or other rear portion of the vehicle and aimed so as to view generally rearward of the vehicle (or optionally the camera may be placed at the trailer and viewing the trailer hitch). With such a placement, the stereo camera may assist in accurate trailer alignment when hitching the trailer to the vehicle (where the camera is placed at the vehicle only when a trailer is to be hitched to the vehicle). Also, with such placement, the system may provide accurate trailer angle detection or positioning when a trailer is connected/hitched to the vehicle (and the camera may be placed at the vehicle or trailer only when a trailer is attached at the vehicle).

Optionally, the camera may be programmable or may receive an input so that the camera or processor or system knows dimensions of the vehicle or trailer. With such prior knowledge of the vehicle or trailer dimensions, the camera may be placed at the trailer or the vehicle and, via image processing of image data captured by the camera as the vehicle or trailer approaches the trailer or vehicle at which the camera is disposed, the camera can determine or estimate the distance of the vehicle or trailer approaching the camera. For example, if the camera includes dimension data of the user's vehicle, the camera may be placed at a trailer and can (via image processing of captured image data) determine or estimate distance of the vehicle as it approaches the trailer for hitching the trailer to the vehicle, and may wireless communicate such determined or estimated distance information to the vehicle or vehicle system or to the driver of the vehicle (such as to the driver's smartphone or the like) so the driver (who may also be viewing images captured by the camera at a display screen of the vehicle or at his/her smartphone) knows how far the trailer is from the vehicle during the hitching maneuver.

Optionally, a wireless camera of the types described herein may be placed at or in a vehicle or trailer and may monitor the interior of the vehicle or trailer. For example, the camera may be placed in a trunk or cabin of the vehicle or inside a trailer to monitor the goods or items in the vehicle or trailer. The camera may determine a change (such as movement of the goods/items or temperature in the vehicle or trailer or the like) and, responsive to the determined change exceeding a threshold level, the camera may generate an alert to the driver of the vehicle. Optionally, a wireless camera placed in the vehicle may function as an occupant monitor to monitor a child or pet in the vehicle. Optionally, a wireless camera placed in the vehicle may function as a climate monitor and/or may provide suggestions to the user during his/her daily routine.

Optionally, a wireless camera of the types described herein may be placed at a vehicle and may communicate with a key fob for the vehicle. With such an application, the camera may provide facial authentication for the user during valet parking. Optionally, the camera may generate an alert to the key fob to provide a vehicle monitor/alert system (such as when monitoring an occupant in the vehicle or trailer) and/or may alert the carrier of the key fob as to temperature and/or weather changes (such as when the vehicle or trailer temperature exceeds a threshold amount of if the camera determines that it has started to rain or the like) so the user can activate a vehicle function accordingly (such as to open or close the windows or sunroof of the vehicle or the like).

Optionally, a wireless camera of the types described herein may be placed at a vehicle or trailer and may be used in conjunction with another vehicle-based camera or the like. For example, the wireless camera (such as a single imager camera) may be placed at the vehicle near to a fixed camera (such as near to the vehicle backup camera) to generate stereo vision, with the system estimating the wireless camera location (proximity to the vehicle camera) using Wi-Fi triangulation inside the vehicle (via a vehicle-based processing system or the like). The wireless camera thus may function with or cooperate with a vehicle camera to provide a stereo vision system, which may have many advantages over monocular vision systems.

Optionally, a wireless camera of the types described herein may be used with authentication systems, where the camera (such as a single imager camera or a dual imager camera that includes a battery and connectivity protocols) may be placed at the user's home as desired and may communicate with an accessory or system of the vehicle or home. For example, such a camera may be disposed at the user's home so as to view the area at or near a garage, and may communicate with a garage door opener. Thus, when the vehicle enters the user's home area (and approaches the garage door), the wireless camera connects to the vehicle network (Bluetooth or Wi-Fi direct) and/or detects license plate of the vehicle (or otherwise confirms that the vehicle is at the garage door area is an authorized vehicle) and triggers the garage door to open automatically.

Optionally, a wireless camera of the types described herein may be attached inside a garage or in a driveway of the vehicle owner's home, thus enabling home zone parking systems that have enhanced detection capabilities of drivable areas, vehicle positioning and obstacle detection. The home zone parking system may utilize aspects of the systems described in U.S. provisional application Ser. No. 62/302,346, filed Mar. 2, 2016, which is hereby incorporated herein by reference in its entirety. Optionally, a wireless camera may be mounted at parking lots and other municipalities (and may communicate captured image data to the system of the vehicle) to assist the driver by providing views that are hidden from the driver's line of sight (and the line of sight of the cameras of the driver's vehicle and trailer), such as views of the area around sharp corners or around buildings or other obstacles.

The trailer vision system of the present invention may utilize aspects of the trailer systems described in U.S. Pat. Nos. 9,085,261 and/or 6,690,268, and/or U.S. Publication Nos. US-2015-0002670; US-2014-0160276; US-2012-0265416; US-2014-0085472 and/or US-2015-0217693, and/or U.S. patent applications, Ser. No. 15/238,005, filed Aug. 16, 2016 (Attorney Docket MAG04 P-2833), and/or Ser. No. 15/367,226, filed Dec. 2, 2016 (Attorney Docket MAG04 P-2895), and/or U.S. provisional application Ser. No. 62/303,546, filed Mar. 4, 2016, which are hereby incorporated herein by reference in their entireties.

The cameras may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EyeQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 8,694,224; 7,005,974; 5,760,962; 5,877,897; 5,796,094; 5,949,331; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 7,881,496; 7,720,580; 7,038,577; 6,882,287; 5,929,786 and/or 5,786,772, which are all hereby incorporated herein by reference in their entireties. The system may communicate with other communication systems via any suitable means, such as by utilizing aspects of the systems described in International Publication Nos. WO 2010/144900; WO 2013/043661 and/or WO 2013/081985, and/or U.S. Publication No. US-2012-0062743, which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or U.S. Publication Nos. US-2006-0061008; US-2006-0050018, and/or US-2012-0162427, which are hereby incorporated herein by reference in their entireties. The display may utilize aspects of the display systems described in U.S. Pat. Nos. 8,427,751 and/or U.S. Publication Nos. US-2014-0333729; US-2014-0139676; US-2015-0092042; US-2015-0232030 and/or US-2016-0209647, which are all hereby incorporated herein by reference in their entireties. Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system for a vehicle towing a trailer, said vision system comprising:
a vehicle transceiver disposed at a vehicle;
a trailer transceiver disposed at a trailer;
at least one trailer camera disposed at the trailer and having a field of view exterior of the trailer;
wherein said trailer transceiver is operable to receive image data captured by said at least one trailer camera and to wirelessly transmit captured image data to said vehicle transceiver disposed at the vehicle when the vehicle is towing the trailer;
a video display screen disposed at the vehicle and viewable by a driver of the vehicle when the vehicle is towing the trailer; and
wherein said video display screen is operable to display video images derived from captured image data received from said trailer transceiver disposed at the trailer by said vehicle transceiver disposed at the vehicle.

2. The vision system of claim 1, comprising a control disposed at the vehicle and comprising an image processor operable to process captured image data received by said vehicle transceiver disposed at the vehicle.

3. The vision system of claim 2, comprising at least one vehicle camera disposed at the vehicle, wherein said image processor of said control is operable to process image data captured by said at least one vehicle camera.

4. The vision system of claim 3, wherein said at least one trailer camera comprises a plurality of trailer cameras, and wherein said at least one vehicle camera comprises a plurality of vehicle cameras.

5. The vision system of claim 1, comprising a trailer control unit, wherein said at least one trailer camera communicates captured image data to said trailer control unit, and wherein said trailer control unit communicates with said trailer transceiver disposed at the trailer.

6. The vision system of claim 5, wherein said at least one trailer camera and said trailer control unit communicate via at least one wired connection.

7. The vision system of claim 6, wherein said trailer control unit communicates with said trailer transceiver via at least one wired connection.

8. The vision system of claim 5, wherein said at least one trailer camera, said trailer control unit and said trailer transceiver are powered via electrical connection of a trailer wiring harness to a vehicle wiring harness at the vehicle when the trailer is hitched to the vehicle.

9. The vision system of claim 1, wherein said trailer transceiver is disposed at a front exterior portion of the trailer remote from said at least one trailer camera.

10. The vision system of claim 1, wherein said at least one trailer camera comprises said trailer transceiver.

11. The vision system of claim 1, wherein said trailer transceiver is operable to receive control signals from said vehicle transceiver.

12. The vision system of claim 1, wherein said vehicle transceiver is disposed at an exterior portion of the vehicle to enhance wireless communication with said trailer transceiver.

13. The vision system of claim 1, wherein said at least one trailer camera comprises a plurality of trailer cameras.

14. A vision system for a vehicle towing a trailer, said vision system comprising:
a vehicle transceiver disposed at a vehicle;
a plurality of vehicle cameras disposed at the vehicle and having respective fields of view exterior of the vehicle;
wherein said plurality of vehicle cameras comprises a rearward viewing vehicle camera disposed at a rear of the vehicle and viewing rearward of the vehicle, a left side vehicle camera disposed at a left side of the vehicle and viewing sideward of the vehicle, and a right side vehicle camera disposed at a right side of the vehicle and viewing sideward of the vehicle;
wherein said vehicle transceiver is operable to receive image data captured by said vehicle cameras;
a trailer transceiver disposed at a trailer;
a plurality of trailer cameras disposed at the trailer and having respective fields of view exterior of the trailer;
wherein said plurality of trailer cameras comprises a rearward viewing trailer camera disposed at a rear of the trailer and viewing rearward of the trailer, a left side trailer camera disposed at a left side of the trailer and viewing sideward of the trailer, and a right side trailer camera disposed at a right side of the trailer and viewing sideward of the trailer;
wherein said trailer transceiver is operable to receive image data captured by said trailer cameras and to wirelessly transmit captured image data to said vehicle transceiver disposed at the vehicle when the vehicle is towing the trailer;
a video display screen disposed at the vehicle and viewable by a driver of the vehicle when the vehicle is towing the trailer;
wherein said video display screen is operable to display video images derived from captured image data received by said vehicle transceiver disposed at the vehicle; and
wherein said video display screen displays surround view video images derived from image data captured by at least said left side vehicle camera, said right side vehicle camera, said rearward viewing trailer camera, said left side trailer camera, and said right side trailer camera.

15. The vision system of claim 14, comprising a control disposed at the vehicle and comprising an image processor operable to process captured image data received by said vehicle transceiver disposed at the vehicle.

16. The vision system of claim 14, comprising a trailer control unit, wherein said trailer cameras communicate captured image data to said trailer control unit, and wherein said trailer control unit communicates with said trailer transceiver disposed at the trailer.

17. The vision system of claim 16, wherein said trailer cameras, said trailer control unit and said trailer transceiver are powered via electrical connection of a trailer wiring harness to a vehicle wiring harness at the vehicle when the trailer is hitched to the vehicle.

18. A vision system for a vehicle towing a trailer, said vision system comprising:
a vehicle transceiver disposed at a vehicle;
a plurality of vehicle cameras disposed at the vehicle and having respective fields of view exterior of the vehicle;
wherein said vehicle transceiver is operable to receive image data captured by said vehicle cameras;
a trailer transceiver disposed at a trailer;
a plurality of trailer cameras disposed at the trailer and having respective fields of view exterior of the trailer;
wherein said trailer cameras and said trailer transceiver are powered via electrical connection of a trailer wiring harness to a vehicle wiring harness at the vehicle when the trailer is hitched to the vehicle;
wherein said trailer transceiver is operable to receive image data captured by said trailer cameras and to wirelessly transmit captured image data to said vehicle transceiver disposed at the vehicle when the vehicle is towing the trailer;
a video display screen disposed at the vehicle and viewable by a driver of the vehicle when the vehicle is towing the trailer;
wherein said video display screen is operable to display video images derived from captured image data received by said vehicle transceiver disposed at the vehicle; and
a control disposed at the vehicle and comprising an image processor operable to process captured image data received by said vehicle transceiver disposed at the vehicle.

19. The vision system of claim 18, wherein said trailer transceiver is disposed at a front exterior portion of the trailer remote from said trailer cameras.

20. The vision system of claim 18, wherein one of said trailer cameras comprises said trailer transceiver.
